(19) United States
(12) Patent Application Publication
(10) Pub. No.: US 2004/0137155 A1
(43) Pub. Date: Jul. 15, 2004

(54) Fog-resistant coatings and methods of making the same

(75) Inventors: Edward A. Bernheim, Corpus Christi, TX (US); Benjamin W. Raglin, Mathis, TX (US)

Correspondence Address: TURNER MOLLERG, Suite 720, 720 American Bank Plaza, 711 N. Carancahua, Corpus Christi, TX, 78475, US

(73) Assignee: Exxene Corporation, Corpus Christi, TX

(21) Appl. No.: 10/341,752

(22) Filed: Jan. 13, 2003

(51) Int. Cl. B05D 3/02; C08G 18/81

(52) U.S. Cl. 427/385.5; 528/65; 528/45

(57) ABSTRACT

This document discloses a clear, polymeric composition that provides both abrasion resistance and non-fogging properties. The composition may be applied to plastic or glass with or without the use of a solvent carrier, or may be cast into a molded article. The fully cured composition provides a fog-free surface that repels condensation while the interior of the polymeric deposition provides a hydrophilic environment for the absorption of water vapor. This combination of properties is highly efficacious and permanent, functioning independent of any additional non-fogging additives. The current invention is composed of an isocyanate prepolymer and a water-soluble polyhydroxl polymer. An absence or surfactants or crosslinking additives/chain extenders makes the current invention innovative amongst prior art, relying totally upon the inventors' use of certain unique material combinations.

### BACKGROUND OF THE INVENTION

Hard coatings have been used to protect plastics and glasses in special applications, e.g., optical lenses, goggles, shields, sunglasses, windshields, sunroofs, etc. Hard coatings may be water repellent but often quickly fog when exposed to high relative humidity.

Normal anti-fogs materials maintain clarity by condensing and spreading water across their hydrophilic surfaces and/or within their hydrophilic upper layer(s), thereby lowering surface tension and providing clarity.

Most anti-fog functionality, however, on the use of surfactant-type additives. If used as a direct, non-reactive additive, these materials provide excellent surface activity but are washed away over time, resulting in diminished anti-fog performance. If the surfactant is reacted into the polymeric molecule it will generally not perform as effectively as an unreacted surfactant material, and will hydrolyze over time, with the same results as the former method. Both methods involving the use of surface-active agents as anti-fog materials fail to perform well at freezing temperatures. The excessive amount of condensate quickly freezes, resulting in loss of clarity.

Another method used to obtain a non-fogging composition utilizes polymers that possess inherent non-fogging characteristics as the majority of the formulation. Water is absorbed into the composition's upper layers, providing clarity by the physical deposition and diffusion of liquid water. These materials may be long-lived but are often soft, resulting in compositions with undesirably low-abrasion resistance. Fog-reducing efficacy is not as vigorous as with the surfactant-type compositions; anti-fog properties are quickly hampered by the inevitable saturation of the hydrophilic materials and their subsequent failure to maintain clarity. Performance at low temperatures is better than surfactant-types but eventually suffers the same fault.

Some non-fogging products utilize water-repellant, or hydrophobic, depositions to prevent the accumulation of condensation. Such compositions generally do very well regardless of temperature. Yet, they have limited utility in areas of very high humidity.

Excessive amounts of water vapor quickly overcome the surface's ability to repel water, resulting in a multitude of very find droplets.

Accordingly, there exists a need for an anti-fog composition capable of functioning independent of variations in humidity and temperature.

### SUMMARY OF THE INVENTION

In one aspect, the invention provides a composition comprising an isocyanate prepolymer containing two or three isocyanate groups and a polyol. The composition is capable of providing a scratch-resistant, water repellent, anti-fog finish, film or shape when cured.

In another aspect, the invention a method of producing a substantially scratch-resistant, anti-fog finish on a substrate. The method includes mixing a blocked isocyanate having two or three isocyanate groups with a polyol to form a mixture. The mixture is then applied to a substrate and cured, thereby forming a scratch-resistant, anti-fog urethane on the substrate.

In yet another aspect, the invention provides a polymer composition comprising a blocked isocyanate prepolymer containing two or three isocyanate groups and a water-soluble or dispersible polyhydroxyl-functional compound. The composition is capable of providing a scratch-resistant, water repellent, anti-fog finish, film or shape when cured at a temperature of about 80° C. to about 180° C. for about 10 to about 60 minutes. The composition is also substantially free of chain extenders and surfactants.

### DETAILED DESCRIPTION OF THE INVENTION

The invention provides a highly scratch-resistant surface composition that also inhibits or prevents fogging of the coated substrate. More particularly, the polyurethane compositions of the present invention may be non-fogging and water repellent, and may maintain excellent abrasion resistance, clarity, and adhesive properties on most plastics and glass. A hydrophilic layer of the composition possesses a water-repellent surface due to the unique material combinations put forth in the invention. Hydrophilic and water-repellent properties are generally achieved without the addition of fog-preventing surfactants or need for chain extenders. This makes the anti-fog composition superior to other materials in anti-fog properties. The composition system may comprise one or more of the following: an isocyanate prepolymer having reactive or blocked isocyanate groups or a blocked isocyanate, a water-soluble or water dispersible polyol, any compatible organic solvents or water (and emulsifier, if water-based), any required catalysts, and Theological additives. The invention can be also cast in a solvent-free state in order to produce a film, or casting molding composition.

The coatings, which are the result of curing mixtures that have been applied to a substrate, tend to possess permanent, non-fogging properties and remain hard enough to be used in the everyday situations required in the applications set forth above, namely, with optical lenses, goggles, shields, sunglasses, windshields, sunroofs etc. By combining a porous, hydrophobic surface with a hydrophilic base polymer, it is possible to obtain a composition possessing excellent anti-fog characteristics and surface hardness.

Composition hardness and adhesive properties may also be significantly improved in order to adapt the coatings to especially difficult substrates. Hydrophilic (anti-fog) properties can also be varied to suit the end product's intended use. Solvent-free, liquid compositions that can be used as coatings or in the casting of molded elements, are also within the scope of the invention. The desired properties of the coatings are discussed in more detail below.

The polymeric composition exhibits excellent surface hardness and water repellent properties without the need for chain extenders or surfactant materials to provide the desired balance of physical and non-fogging properties. Accordingly, many of the coatings described herein are “substantially free” of chain extenders or surfactant materials. In this instance, “substantially free” means having less than about 3%, more particularly less than about 1%, and more typically, 0.5% to 0% of chain extender or surfactant. The hydrophobic nature of the surface reduces the presence of water deposited on the surface. Any water that is deposited thereon may be absorbed through the porous surface layers and absorbed into the coating's hydrophilic interior. This combination of hydrophilic and hydrophobic properties provides a very effective non-fogging and scratch resistant surface.

Normal anti-fogs are most often solely used on the inside of components. A second coating (usually a protective hardcoating) may then need to be applied to the exterior surfaces to protect it from everyday wear and abrasion. The water repellency and hardness of the composition of the present invention, however, allows this coating to be used on both sides of a part. This is economical as the parts can be dip-coated, the most efficient method of coating. In other words, it alleviates the need to provide an additional protective hardcoating.

The Composition

The composition system typically comprises an isocyanate prepolymer with reactive isocyanate groups or a blocked isocyanate, and a water-soluble or water dispersible polyol. The system may further comprise, although it need not, appropriate organic solvents or water, emulsifiers, and coalescent, catalysts, and paint additives (typically at levels below 1% by weight). The reaction of the isocyanate and the polyol forms a part hydrophilic and part hydrophobic polyurethane composition when reacted and cured under particular conditions. By varying the type of isocyanate, the type and molecular weight of the polyol, the percent solids of the material and the catalyst, the hardness, fog resistance, efficacy, and other physical and chemical properties can be varied.

More specifically, the coating may be the product of the reaction, usually under heat, of an isocyanate prepolymer and a polyalkylene glycol. Isocyanate adducts and prepolymers particularly effective in the invention include blocked and unblocked cyclic or aliphatic diisocyanates. Polyalkylene glycol polymers that may be used include diols, multi-functional variants such as tri- and tetrahydroxy glycols, branched ethylene oxide/propylene glycol copolymers and block polymers of the above. Catalysts may include the common organometallic materials normally used to produce polyurethane substances. Specifically, dibutyl tin dilaurate may be used as an acceptable catalyst. Other additions include solvents, and rheological additives. The inclusion of catalytic substances is pendent on the choice of polymeric functionality and the intended cure schedule. Thus, some materials function well without the usual polyurethane initiators.

These materials are described in more detail below.

Isocyanates

Typically, the isocyanate prepolymers used to prepare the coatings contain 2 or 3 isocyanate groups, although more groups are certainly acceptable. Examples of isocyanate systems include a biuret or an isocyanurate of a diisocyanate, triisocyanate or polyisocyanate. The following are typical diisocyanates prepolymers that may be used: hexamethylene diisocyanate, diisophorone diisocyanate, and toluene diisocyanate. Blocked isocyanates may also be used in order to address ingredient limitations and stability problems.

Mixtures having the blocked polyisocyanates may be applied using any of the application techniques discussed herein. Typically, mixtures having the blocked polyisocyanates are cured or heated after having been applied to a plastic or glass substrate. During heating, the blocked polyisocyanates dissociate so that the isocyanate groups become available to react with the active groups of the polyols (discussed in more detail below), thereby leading to substantial crosslinking and hardening of the coating. Blocked isocyanates are isocyanates in which at least one isocyanate group has reacted with a protecting or blocking agent to form a derivative which will dissociate on heating to remove the protecting or blocking agent and release the reactive isocyanate group.

Examples of blocking agents for polyisocyanates include aliphatic, cyclo-aliphatic or aralkyl monobydric alcohols, hydroxylamines and ketoximes. Other examples of applicable blocking agent functionalities include the following: oximes (compounds containing the radical —CH(:N.OH)), pyrazoles, phenols and caprolactams. Typical pyrazoles are 4 membered rings having the following formula:

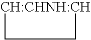

Blocked isocyanates and combinations of the above also produce effective formulations.

Most of these blocked polyisocyanates tend to dissociate at temperatures of about 90° C. to about 180° C. (160° C.). Other blocked polyisocyanates, however, may dissociate at lower temperatures, especially when used in the company of a catalyst. For example, the temperature to which the coated article must be heated may generally fall to about 100 to 140° C. when using the polyisocyanates discussed below. The presence of a catalyst may increase the rate of reaction between the liberated polyisocyanate and the active hydroxyl group of the polyol. Examples of blocked polyisocyanates having a lower dissociation temperature include compounds having the following formulas:

R—Y^{m} FORMULA A

wherein R is a cycloaliphatic, heterocyclic, m valent aliphatic, or aromatic residue and each Y, which may be the same or different, is

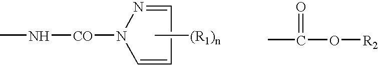

group where R₂ is a C₁-C₄ alkyl group,

n is 0, 1, 2, or 3

and m is an integer al, preferable 2-6.

When R₁ may represents an alkyl or alkenyl group and may contain up to 4 carbon atoms. R₁ may also be an aralkyl group, wherein the aryl portion may be phenyl and that the alkyl portion may contain 1 to 4 carbon atoms. When R₁ is a halogen, it may typically be chlorine or bromine.

The blocked polyisocyanate of the formula A is formed by admixing the polyisocyanate

R(NCO)ₘ

with a sufficient quantity of a pyrazole of the formula:

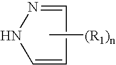

such that the reaction product contains substantially no free isocyanate groups and is a urea of formula I. This reaction is exothermic and since the reaction product will dissociate if the temperature is raised sufficiently, cooling may be required to keep the temperature of the reaction mixture down, preferably to 80° C. or less.

Other blocking agents used in the present invention may be pyrazoles of the formula:

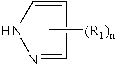

where R₁ and n are as defined above. Examples of the pyrazoles include, but are not limited to, 3,5-dimethylpyrazole, 3-methylpyrazole, 4-nitro-3,5-dimethylpyrazole and 4-bromo-3,5-dimethylpyrazole.

Some of these pyrazoles can be made by converting acetylacetone (AA) into a derivative that will react with hydrazine to give the desired pyrazole as shown below:

AA+Nₐ+CH₂=CHCH₂Cl□Ac₂CHCH₂CH=CH₂

AA+Nₐ+PhCH₂Cl□Ac₂CHCH₂Ph

AA+PhNCO□Ac₂CHCONHPh

The polyisocyanate which is to be blocked may be any organic polyisocyanate suitable for crosslinking compounds containing active hydrogen, e.g., those listed above as well as aliphatics including cycloaliphatic, aromatic, heterocyclic, and mixed aliphatic aromatic polyisocyanates containing 2, 3 or more isocyanate groups. The group R will normally be a hydrocarbon group but substitution, e.g., by alkoxy groups is possible.

Other blocked isocyanates may include, but should not be limited to, dhexamethylene diisocyanate, toluene diisocyanate, diphenylmethane diisocyanate, bis(methylcyclohexyl) diisocyanate, oxime blocked hexamethylene diisocyanate, diethyl malonate blocked toluene diisocyanate. The isocyanate may also be a biurate, e.g., defined as the partial reaction of a polyisocyanate with hydroxyl or amine components to increase terminal isocyanate groups. All isocyanates listed as Desmodur tradenames may also be used, including, Desmodur 75, which is a hexamethylene diisocyanate.

Other isocyanate compounds may be, for example, ethylene diisocyanate, propylene diisocyanate, tetramethylene diisocyanate, decamethylene diisocyanate, dodecamethylene diisocyanate, 2,4,4-trimethylhexamethylene-1,6 diisocyanate, phenylene diisocyanate, tolylene or naphthylene diisocyanate, 4,4′-methylene-bis (phenyl isocyanate), 4,4′-ethylene-bis (phenyl isocyanate), [symbol] , [symbol] -diisocyanato-1,3-dimethyl benzene, [symbol] , [symbol] ′-diisocyanato-1,3-dimethylcyclohexane, 1-methyl-2,4-diisocyanato cyclohexane, 4,4′-methylene-bis (cyclohexyl isocyanate), 3-isocyanato-methyl-3,5,5-trimethyl cyclohexyl isocyanate, dimer acid-diisocyanate, [symbol] , [symbol] ′-diisocyanato-diethyl benzene, [symbol] , [symbol] ′-diisocyanatodimethyl cyclohexyl benzene, [symbol] , [symbol] ′-diisocyanatodimethyl toluene, [symbol] , [symbol] ′-diisocyanato-dietbyl toluene, fumaric acid-bis (2-isocyanato ethyl)ester or triphenyl-methane-triisocyanate, 1,4-bis-(2-isocyanato prop-2yl)benzene, 1,3-bis-(2-isocyanato prop-2yl)benzene.

These isocyanates are commercially available from manufacturers and distributors such as DuPont, Dow, Cytec, PPG, Crompton, Bayer, and Baxenden. Typically, the isocyanates that are used have low molecular weights, e.g., hexamethylene diisocyanate and toluene diisocyanate, in order to maximize the available anti-fog effect.

Use can also be made of polyisocyanates obtained by reaction of an excess amount of the isocyanate with a) water, b) a lower molecular weight polyol (e.g. m.w.<=300) or c) a medium molecular weight polyol, e.g. a polyol of greater than 300 and less than 8000 m.w., eg sucrose, or by the reaction of the isocyanate with itself to give an isocyanurate. The lower molecular weight polyol comprises, for example, ethylene glycol, propylene glycol, 1,3-butylene glycol, neopentyl glycol, 2,2,4-trimethyl-1,3-pentane diol, hexamethylene glycol, cyclohexane dimethanol, hydrogenated bisphenol-A, trimethylol propane, trimethylol ethane, 1,2,6-hexane triol, glycerine, sorbitol or pentaerythritol.

Polyols

Typical polyols used in conjunction with the invention have a molecular weight of at least about 90, and more particularly at least about 600, and most typically at least about 800. The molecular weight of the polyols will generally be less than about 30,000, more particularly less than about 12,000, even more particularly less than about 4000, and typically below 1500. The polyols used in conjunction with the invention may be straight, branched, or cyclic.

Examples of some of the many possible polyols include polyalkylene glycols such as polyethylene glycols (PEGs), and polypropylene glycols (PPGs). A general formula for polyalkylene glycols follows: H(OR)ₙOH, wherein R is an alkyl group and n>10. A general formula for polyethylene glycols is H(OCH₂CH₂)ₙOH, wherein n is >2. A general formula for polypropylene glycol is H(OCH₂CH₂CH₂)ₙOH, wherein n is >2. Typically, the polyols are water soluble or dispersible. Block polymers of polyalkylene glycols, and more particularly, block polymers of polyethylene glycol and polypropylene glycols may be used. Even more particularly, polyethylene-90 or polyethylene-180 may commonly be used. Polyoxyethylene glycols can also be employed.

While a very wide variety of polyols may be used, the typical system will employ at least one of polyalkylene glycols, water soluble triols, tetrahydroxy-functional branched ethylene oxide/propylene glycol copolymers, block polymers thereof, and combinations thereof. Other variations include water soluble triols or glycerin polymers and other multi-functional, branched polyhydroxyl compounds such as tetrahydroxy functional copolymer of ethylene oxide and propylene glycol, and/or block polymer combinations of any of the above. Tetrahydoxy functional-branched/ethylene oxide/propylene glycol co-polymers may also be used.

Catalysts

Catalysts may or may not be employed in conjunction with the mixtures and coatings of the present invention. When used, a wide variety of catalysts that are known in the art may be employed. For example, catalysts such as dibutyl tin dilaurate or triethylene diamine may be used. In addition, other catalysts that may be used include, but are not limited to, the following: amines such as tetramethylbutanediamine; azines such as 1,4 diaza(2,2,2)bicyclooctane; and other organotin compounds such as tinoctoate. These catalysts may facilitate the reaction and may be used to complete the cure of the mixture.

More particularly, catalysts may be effective, during heating, to facilitate the dissociation of the blocked polyisocyanates so that the isocyanate groups become available to react with the active groups of the polyols, thereby leading to substantial crosslinking and hardening of the coating

Solvents

The mixtures of the present invention may or may not comprise at least one solvent. A wide variety of solvents may be used and will be understood by those of ordinary skill in the art. For example, tertiary butyl alcohol, as shown below, may be used:

CH₃

CH₃—C—OH

CH₃

Other solvents that may be used include diacetone alcohol, primary and secondary alcohol. A non-polar solvent that may be used is xylene, although polar solvents tend to work better.

In the case of coatings using reactive isocyanates, non-reactive solvents such as tertiary butyl alcohol, diacetone alcohol, isophorone, glycol ether EB (2-butoxy ethanol), and the like are used. In these systems, the greater part of the solvent mixture is composed of polar solvents without primary or secondary alcohols. Smaller amounts of aliphatics, aromatics and other non-polar solvents may then make up the remainder, if so desired.

The systems can be prepared solvent free. This form of the invention may be used to produce film, cast/molded objects, and co-extruded materials. Using methods well known to the industry, the production of thin films, solids sheets, and monolithic shapes, (i.e., lenses, 3-dimensional objects, etc.) is thus possible.

In systems using blocked isocyanates, most solvents are applicable. Any of various solvents including alcohols, ketones, aromatics, and aliphatics may be used depending upon the specific substrate and/or application and curing environments.

Rheological Agents

The mixtures and coatings of the present invention may also comprise rheological additives. Rheological agents may also be added to increase film thickness without increasing solids, to stabilize the coatings, control slip, flow and/or leveling difficulties. Examples of rheological agents include, but are not limited to, ethyl cellulose, methyl cellulose, associative PUR thickeners, anti-mar agents, and combinations thereof. Examples may include DC 28 distributed by Dow Corning, or L-7602 and L-7608 obtained from Crompton of Pittsburg, Pa., some of which are polyether silicone flow/level agents.

The Mixture

Typically, the mixtures of the present invention comprise the following:

| | |
|---|---|
| Polyol | About 10.0% to about 85.0% by weight; |
| Isocyanate | About 15.0% to about 90.0% by weight; |
| Catalyst | About 0.0% to about 2.0% by weight; |
| Solvent | About 0.0% to about 95.0% by weight; and |
| Rheological Agent | About 0% to about 2% by weight. |

These components are weighed out using techniques that are generally known in the art. Some or all of the components are then mixed using simple mixing, admixing, homogenization, or a combination thereof in order to form the mixture. This initial mixing is typically performed at ambient conditions, namely, ambient temperatures and pressures. Each of these mixing techniques is well-known in the art.

The mixtures may then be applied to a variety of substrates using a variety of techniques that are well-known in the art. For example, the mixtures discussed herein may be applied to glass and plastic. Regarding glass, the hardness, tintability, water repellency, and hydrophilicity are properties to consider when choosing the glass. On plastics, the properties are hardness, tintability using hot dye at 90° C., water repellency, hydrophilicity, flexibility, thermoformability using heat and/or pressure, and adhesion. Examples of possible plastic substrates include, but are not limited to, polycarbonate, allyl diglycol carbonates or copolymers thereof, acrylic, acrylics, urethanes, polysulfone, polyarylate, PETG, PET, polyolefins, and combinations thereof. The selection of the base components are equally as important. For example, the selection of an aliphatic polyurethane base contributes to good resistance to adverse weather conditions and solar aging/ultraviolet rays.

The mixtures may be applied to these substrates using a variety of techniques that are well-known in the art. For example, the mixtures may be sprayed onto the substrate using high pressure spray applications. Additionally, the substrate may be dipped into the mixture. Flow, spin, curtain, and blade techniques may also be used.

Subsequently, after the mixture is applied to the substrate, the mixture is exposed to ambient conditions. Typically, the exposure will be for greater than about one minute, and more particularly greater than about 10 minutes. The exposure to ambient conditions after application is generally less than about 60 minutes, and more particularly less than about 40 minutes. The mixtures are generally exposed to ambient conditions in order to let any solvents in the mixture evaporate.

The mixture is then cured. Typically, the mixture is cured at a temperature that is greater than 80° C., more particularly greater than 100° C., and even more particularly greater than 125° C. Curing is usually performed at temperatures that are less than about 180° C., more particularly less than about 135° C., and even more particularly less than about 125° C. Curing times may vary. Typically, the mixture is cured for at least about 10 minutes, more particularly at least about 20 minutes, and even more particularly at least about 40 minutes. Curing times are generally less than about 60 minutes, and more particularly less than about 40 minutes. Overall, the curing temperature and time will depend on the substrate melting point, as well as the types and molecular weights of the isocyanate, polyol, blocking agent being used. The intended use of the part may also dictate the curing time and temperature. Again when using a blocked isocyanate, the curing time and temperature must be sufficient to enable the blocker to dissociate, thereby allowing the isocyanate group to react with the hydroxyl groups and cross-link. Generally, the mixtures that are applied to the substrates are the result of at least one of the pre-polymers isocyanates at least partially reacting with at least one of the polyols. The resultant mixture, accordingly, is typically a cross-linked polyurethane.

Alteration of the amount of the individual components, i.e. ratios of solvent, polyols, isocyanates, etc. results in products having variable functional properties. The coatings and compositions of the present invention may possess a variety of chemical and physical properties and functionalities.

The resulting cured coating is part hydrophilic and part hydrophobic. More particularly, the surface is hydrophobic, while the interior is hydrophilic. By combining a porous, hydrophobic surface with a hydrophilic base polymer, it is possible to obtain a composition possessing excellent anti-fog characteristics and surface hardness. The absorbent polymer coating of the invention possesses a water-repellant surface due to the unique material combinations set forth in the application. This hydrophobic surface is achieved, while maintaining a hydrophilic core layer, by substantially excluding surfactants and using higher molecular weight polyols as discussed herein. Increasing the molecular weight of the polyols tends to produce increasingly more non-polar polyurethanes after reaction with the isocyanates discussed above. These higher molecular weight polyurethanes contribute to the water-repellancy of the coatings.

In terms of hydrophobicity, water will run off part of the coating when applied to a substrate. Part of the water is actually repelled. The surfaces of these coatings generally do not tend to sheet and generally do not tend to be wet by water. This is due to the surface tension of the coating, which substantiates the water-repellancy or hydrophobicity of the coatings. Typically, the surface tension of the surface of the coatings will be greater than about 15 dynes/cm², more particularly, greater than about 20 dynes/cm², and even more particularly, greater than about 25 dynes/cm². The surface tension is typically less than about 60 dynes/cm², although the surface tension may be less than about 50 dynes/cm², or even less than about 45 dynes/cm². The surface tension of the coatings was tested according to the Wilhelmy Plate Method, which is well-known or readily ascertainable to one of ordinary skill in the art.

Cured coatings of the present invention that are products of the reaction of polyols having molecular weights of less than about 600 (see Example 1 below) may tend to have a surface tension of about 56 to about 61 dynes/cm². Polyurethanes made from polyols having molecular weights of about 600-800 (see Example 6), about 800-1500 (see Example 4), about 15004600 (see Example 3), and even about 12,000 tend to have surface tensions of about 50-57 dynes/cm², about 27-38 dynes/cm², about 23-25 dynes/cm² and about 21 dynes/cm², respectively. The lower the measurement in terms of dynes/cm², the more hydrophobic the surface. In other words, the low surface tension means that water is actually repelled (i.e. it beads off), rather than being sheeted or absorbed. Accordingly, by using polyols having higher molecular weights, the resulting polyurethanes exhibit more hydrophobic tendencies, at least at the surface.

As discussed above, however, the coatings described herein also have a hydrophilic interior portion. Hydrophilicity may be measured according to weight gain the coatings experience upon aqueous immersion. More specifically, “hydrophilicity” is a measure of the percent weight gain experienced by a coating that has been fully immersed in an aqueous medium for 96 hours at about 20 to 25° C. In other words, during this period, the coating will tend to attract a certain amount of water. The difference between the weight of the coating after being immersed and the weight of the coating before immersion, as expressed as a percent weight gain (as compared to the weight of the non-immersed coating) measures the hydrophilicity of the coating. In other words, the difference between the mass of the soaked coating and the dry coating measures the hydrophilicity of the coatings. Typically, the coatings described herein tend to gain greater than 20% weight, more particularly greater than 30% weight, and often times greater than 35% weight. Weight gain is generally less than about 150%, and typically the weight gain is less than 140%, and more particularly less than about 110%.

As shown in more detail below in the Examples, polyurethanes made from polyols having a molecular weight around 400 (see Example 1) may experience a weight gain of about 140% when exposed to the conditions discussed above. Polyurethanes made from polyols having molecular weights of about 800-1500 (see Example 2) experience a weight gain of somewhere between about 75 and about 105%, while polyurethanes made from polyols having molecular weights of about 4600 may exhibit a weight gain of around 35%. Typically, the higher the molecular weight of the polyol being used to form the coating, the less hydrophilic the hydrophilic portion of the coating will be. For the most part, general interpolation may be used to roughly determine the hydrophilicity of coatings discussed herein based on these numbers.

In addition, the coatings possess excellent anti-fogging characteristics after being cured. Accordingly, the coatings are suitable for a variety of applications including, but not limited to, eyewear, optics, automotive and residential glass surfaces, and flat, sheet stock. Again, the cured anti-fog coatings have the ability to both repel and absorb water, rather than just sheet water. More particularly, the coatings of the present invention have the ability to pass EN-166, EN-168, and ENE-2205 (analogous to the ASTM D 4060 abrasion test described herein) tests, each of which is a standardized test, the specifications for which can be obtained from the European Union. More particularly, the coatings described herein may be able to pass the EN-166 test for over a minute, and often times for over five minutes.

Glass or plastic (that is usually transparent) coated with the coatings described herein tends not to fog when first exposed to a “cool environment,” in which the temperature is between about 10° C. to about −25° C., for greater than about thirty seconds and then subsequently exposed to ambient conditions. At these temperatures, the relative humidity, of course, will be very low. More particularly, even after being exposed to the cool environment as set forth above for more than one minute, many of the glass or plastic substrates will not fog regardless of the amount of time they are exposed to ambient conditions. In more detail, the substrates will not fog after being exposed to the cool environment for a minute or more, and then being exposed to ambient conditions for ten seconds, thirty seconds, and even three minutes or more of exposure. Again, many of the coated substrates will not fog after ambient exposure for more than five minutes, more than ten minutes, and even indefinitely after being removed from the cool environment, after having been there for a minute or longer.

More particularly, in one set of experiments, transparent glass and plastic substrates coated with the coatings set forth herein were exposed to a variety of temperatures falling with the cool environment for about one minute, and then were exposed to ambient conditions. Many of the substrates did not fog after being exposed to the ambient conditions for 10 seconds, thirty seconds, and even three minutes and longer. In fact, many of the coatings never fogged at all under these conditions. In another set of experiments, different coated transparent glass and plastic substrates were exposed to different temperatures within the cool environment for about five minutes and longer. The substrates were then removed and exposed to different ambient conditions. The substrates did not fog after 10 seconds. In fact, many of the substrates did not fog after thirty seconds, after three minutes, after five minutes, after ten minutes and longer. Again, many of the substrates never fogged.

Typically, ambient conditions include ambient temperatures and humidities. More particularly, ambient temperatures include temperatures that are typically greater than 10° C, and generally greater than 15° C. Ambient temperatures are usually less than about 125° C., typically less than about 95° C., and more particularly less than about 90° C. Ambient relative humidities for these tests were generally from about 50 to 100%, typically between about 55 to 95%, and more particularly between about 65 to 90%. Most typical of the ambient conditions is about 18° C. to about 30° C. and a relative humidity about 60 to about 85%.

Curing the mixtures also results in coatings that have excellent hardness characteristics as demonstrated by testing as specified by ASTM D 4060. More particularly, the coatings tend to have a taber haze of less than about 10% at 100 cycles with 500 gram load and a CS-10F load, and more specifically less than about 5%. Some of the coatings described herein may have a taber haze of less than about 3% or even 1%. Typically, known anti-fog coatings exhibit a taber haze of greater than 15%. Most polysiloxane hardcoats typically exhibit a taber haze of 3 or greater.

When testing the coatings according to ASTM 3363 described in more detail below, the coatings tend to exhibit a hardness of greater than about 2H, and typically greater than about 4H. Generally, the hardness is less than about 8H, and less than about 6H. Note pencil hardness scale (from hardest, 10H, down to 10H or, simply, 1H, then to HB, F, 1B, down to the softest (6B). The pencils' lower 10-15 mm is trimmed of wood, leaving only the central lead core extending out of the body of the pencil. Then the lead is held perpendicular to a flat surface upon which a piece of fine sandpaper is mounted. The protruding section of lead then is abraded @ 90°, so as to render the tip of the lead perfectly flat and perpendicular to the pencil's length. The hardness test is performed by applying a pencil hardness tester consisting of a rolling tester weighing 200 g and fixing the pencil at a 45° angle through the body of the tester and extending onto the test surface below. The device is moved across the sample (laid flat, horizontally on a hard, level surface) for a distance of about 24 mm. As it moves, the pencil's lead (at a 45° angle) will incise/etch a scratch/line into the sample surface if the pencil's graphite/hardness rating is harder than the sample's coated surface. Hardness is rated as the hardest lead that does not leave a visible score.

The coatings of the present invention may also have excellent adhesion properties as indicated by the coatings' ability to pass the ASTM B 3359 Method B discussed herein. For example, many of the coatings can withstand at least one, three or even five pulls with standard Scotch tape 3M 160 on 100 square hatch with no pull up. Moreover, some of the coatings can even withstand boiling water exposure, and pass 120 minute adhesion tests.

The coatings also tend to be substantially clear. This property makes the coatings ideal for substrates that are transparent. In other words, the coatings do not blur or obstruct vision through transparent substrates. When applied to transparent substrates, the coatings may exhibit less than 0.5% detectable haze by hazemeter, more particularly less than 0.3% detectable haze by hazemeter, and even more particularly less than 0.2% detectable haze by hazemeter.

The life of the coating, when applied to a substrate, is typically greater than about 2 years, but may be greater than about 5 years, and may even be longer than about 10 years. The shelf-life of the mixtures are also excellent. Compositions may be formulated into single- or dual-component (2K) forms. This allows the selection of unique reactive materials to suit the various needs of the end product. Typically, the shelf life of the mixtures is at least about 6 months, sometimes at least about 1 year, and at times at least about 2 years.

The coatings also exhibit exceptional thermoformability. More particularly, the coatings have been applied to substrates and then bent between two pieces of curve metal under high heat, more particularly, temperatures greater than about 150° C., and even greater than about 180° C. for about 1 to about 2 minutes. The coatings did not crack or lose adhesion properties during this test.

The coatings after being cured tend to have a thickness of at least about one micron, more particularly greater than about 3 microns, and typically greater than about 5 microns. The thicknesses also tend to be less than about 30 microns, more particularly less than about 20 microns, and typically less that about 15 microns.

Resulting urethanes also accept commercially-available color tints and functional solution treatments (i.e. non-fogging, uv-filtration, anti-static) utilized by the retail optical industry.

The present invention is further explained by the following examples that should not be construed by way of limiting the scope of the present invention.

### EXAMPLES

### Example 1

To illustrate the preparation of an abrasion resistant anti-fog coating with a hydrophilic surface. Part A was mixed using simple mixing, namely, a magnetic stir bar and plate with Part B. Part A comprised about 28.1 grams Desmodur N-75 (Bayer) well mixed with about 21.9 grams of diacetone alcohol. Part B comprised about 37.8 grams of diacetone well mixed with about 11.0 grams PEG-90, 0.2 grams dibutyltin dilaurate, and DC-57 additive (Dow Corning). The mixture was immediately applied to a 4“square of Lexan polycarbonate, via an airbrush. The mixture was then allowed to stand at ambient conditions for about 10 minutes. It was then baked for one hour at 125° C. The sample had excellent anti-fog properties when blown on. A 100-cycle taber abrasion test resulted in a haze of less than 5% using a dual, 500-gram load and a CS-10F abraser wheel. Note that the light transmittance of the coated sample exceeded the uncoated polycarbonate (approx. 92% before coating application). Separately, each part exhibited a shelf life of over 6 months with no loss of performance properties after mixing appropriately. The pot life of the prepared/mixed composition is 24 to 36 hours. See Table I for summarized performance properties.

### Example 2

Part A was mixed with Part B using simple stirring, namely, a magnetic stir bar and plate to form the mixture. Part A comprised 28.1 grams of Desmodur N-75 (Bayer) well mixed with 21.9 grams of diacetone alcohol. Part B comprised 35.8 grams of diacetone well mixed with 13.9 grams of polyethylene glycol-180, 0.2 grams of dibutyl tin dilaurate, and 0.05 grams of DC-57 manufactured by Dow Corning. The mixture was immediately applied by flow-coating to a 4″ square of Teflon coated metal, and allowed to stand at ambient conditions for about 5-10 minutes. The cooled, cured film was peeled from the teflon surface and wrapped around a 0.5″ steel rod to observe the flexibility of the film. No crazing or marring was observed even after wrapping the cured film around itself multiple times. The film shows excellent anti-fog properties when blown on or exposed to changes in humidity and temperatures. Condensed water vapor reduces clarity after a few minutes of exposure. The film exhibited excellent anti-fog properties when blown on, it fills light scratches produced by 6H pencil, and had exceptional flexibility. These coatings resist cracking when rolled into a circular shape.

See Table I for summarized performance properties.

### Example 3

Example 3 illustrates the preparation of a water-repellant, anti-fog coating for low-temperature usage. In a 1-L beaker equipped with a magnetic stirrer and a heating mantle, about 200 grams Baxenden 7683 obtained by Baxenden was stirred with about 281 grams of diacetone alcohol to produce a solution of blocked polyisocyante in solvent. The solution was then heated to 60° C. To the heated, stirring solution was added a solution of 179 g of PEG-4600 in about 179 grams of diacetone alcohol. The solution was stirred and maintained at 60° C. for about 10 minutes. Then 1.6 grams each of dibutylyin dilaurated, and DC-57 additive (Dow Corning) were stirred in to produce a coating composition. The heated mixture was then applied to glass panels via flowcoating, and allowed to hang vertically at ambient conditions for 5 minutes. Samples were then baked for about 25 minutes at 150° C. Subsequently, the cooled, cured samples were exposed to −25° C. for 10 minutes, and then exposed to ambient conditions (25° C., 70 to 75% relative humidity) for about 15 minutes. This was repeated 20 times. The coated glass was found to maintain clarity and did not collect excessive moisture on its coated surfaces. The surface tension was found to be about 23 dynes/sq cm compared to the untreated glass having a surface tension of about 76-78 dynes/sq cm (this quantifies the hydrophobic nature of the surface of the invention when prepared with higher molecular weight polyols). See Table I for summarized performance properties.

### Example 4

To illustrate the preparation of a water repellant, anti-fog coating, about 396 grams Desmodur N-75 (Bayer) was stirred with about 193 grams of diacetone alcohol in a 1-L beaker equipped with a magnetic stirrer, in order to produce a solution of blocked polyisocyante in solvent. To the stirring solution was added a solution of about 147 grams of PEG-1500 in about 147 grams of diacetone alcohol. Subsequently, about 2.2 grams of dibutylyin dilaurate, about 0.5 grams of FC-4430 (3M of Minnesota)—flow/leveling aid, and about 1.0 grams of Silwet L-7602—slip/anti-mar agent (Crompton) were added, with stirring, to produce a low-viscosity coating composition. Commercial ADC (allyl diglycol carbonate, CR-39) panels, 4 inch by 4 inch, were etched, cleaned, and then dipped into the filtered coating solution using a 4.5 inch/minute withdrawal rate. Coated samples were then baked for 90 minutes at 105° C. The cured samples were found to perform very well. Surface tension measured after conditioning at about 20-22° C.; 70 to 75% relative humidity for about 24 hours: 27-29 dynes/sq cm. See Table I for summarized performance properties.

### Example 5

To illustrate another preparation of a water-repellant, anti-fog coating, a solution of 115 grams of a DEM (diethyl malonate)-blocked hexamethylene diisocyante prepolymer containing 70% solids (Baxenden 7963), by weight in methoxypropanol (glycol ether PM) was added to 100 grams of 2-butoxethanol (glycol ether EB). To this stirring solution was added: 1.1 grams of DBTDL (dibutyl tin dilaurate), 10% in EB. Then, 38.5 grams of a monohydroxy, -monobutoxy-functional polypropelene polyglycol (B01/120 form Clariant Germany) and 20.0 grams of a polycaprolactone (CAPA 3091 from Solvay UK) were added. Finally, a solution of 0.8 grams of DC-57, and 1.5 g. of Silwet L-7608—leveling & air release aid in 150 grams of DA were added to complete the coating formulation. Polyamide lenses (trogamid brand) were cleaned, flow-coated with the solution at 20° C. and then suspended vertically for 15 minutes to allow solvents to partially evaporate. Coated samples were cured in a convention oven. After 120 minutes at about 109° C., the samples were removed and cooled. Anti-fog properties were excellent, and accelerated weathering (QUV test cabinet from Q-Panel Corp) tests indicated excellent resistance to UV and moisture. See Table I for summarized performance properties.

### Example 6

To illustrate the production of a 3-dimensional shape (monolith) exhibiting permanent, intrinsic anti-fog properties. A mixture of about 5500 grams of caprolactam-blocked, 100% solids TDI prepolymer product (Baxenden BI 7773), about 1200 grams of PEG-800, and 2220 grams of a polyethylene glycol monomethyl ether having a molecular weight of 720-780 (M750 from Clariant) were stirred together at room temperature. To the well-mixed liquid was added about 5.4 g of DBTDL and about 0.5 g of tin diocctoate. The liquid molding composition was cast into a rectangular solids measuring 100 cm×100 cm×1 cm thick. The sample was cast between two glass plates that were sealed with a silicone elastomeric gasket, and cured at 165° C. for 2 hours. After cooling and removal from the mold, the solidified sample exhibited excellent optical properties and good hardness. Non-fogging properties were excellent on all surfaces. The lenses were also tinted and treated to block UV using a hot (90-92C) aqueous solution of Electron Beam Gray and UV-Shield (BPI of Miami Fla.). After 10 minutes of exposure, the lenses were rinsed and dried. Luminous transmittance of the gray lenses was less than 40%; UV transmittance was <2%. See Table I for summarized performance properties.

TABLE I

| | | | Taber | | | | | | |
|---|---|---|---|---|---|---|---|---|---|
| | | | Test % | Adhesion | Pencil | Chemical | Impact | | Water Soak- |
| ID | LT %¹ | Haze %² | Haze³ | %⁴ | hardness⁵ | Resistance⁶ | Resist⁷ | Anti-fog⁸ | AF⁹ |
| 1 | >97.4 | <0.5% | 4.7 | 100 | 6H | Fail Acetone | PASS | Pass 40 s | Fall 20 s |
| | | | | | | Pass Others | | | |
| 2 | >99.1 | <0.1 | 3.9 | 100 | -na- | Pass all | -na- | -na- | -na- |
| 3 | >98.0 | <0.3 | 1.8 | 90/100* | 8H | Pass all | -na- | Pass 5 min | Pass 5 min |
| 4 | >96.8 | <0.2 | 2.2 | 100 | 4H | Fail Acetone | PASS | Pass 3 min | Pass 2 min |
| | | | | | | Fail Xlene | | | |
| | | | | | | Pass others | | | |
| 5 | >92.5 | <0.5 | 1.1 | 100 | 4H | Fail | PASS | Pass 2 min | Pass 2 min |
| | | | | | | isopropanol** | | | |
| | | | | | | Pass others | | | |
| 6 | >94.3 | <0.5 | 0.78 | -na- | 5H | Pass all | PASS | Pass | Pass Infinite |
| | | | | | | | | Infinite | |

*Example #3, when repeated using an air-dry primer prepared from 0.5% Silquest A-1100 in isobutanol. The primer was stirred and sprayed onto the glass substrate. After 30 minutes of air-dying, the composition from Example #3 was applied and cured as before. Adhesion was excellent.
**Isopropanol exposure resulted in the appearance of visible haze-polyamide substrates are attacked by alcohols.
¹ASTM (American Society for Testing and Materials) E 1348: Test Method for Transmittance by Spectrophotometry using Hemispherical Geometry
²ASTM E 284: Reflection Haze
³ASTM D 4060: Method of Abrasion Resistance of Organic Coatings-100 cycles under a dual, 500 gram load using a standard Taber Apraser device [CS-10F Calibrase Abraser wheel]
⁴ASTM D 3359 Method B: Standard Test Methods of Measuring Adhesion by Tape Test
⁵ASTM D 3363: Test Method for Film Hardness
⁶ASTM D 1308: Test Method for Effects of Household Chemicals on Clear Organic Finishes. Chemicals include: isopropanol 70%, acetone, petroleum ether/hexane, xylene, ammonia, acetic acid, hydrochloric acid, Windex, cola/coffee/tea, sweat/saline, and water.
⁷ASTM D 2794: Test for Method of Resistance of Organic Coatings to the Effects of Rapid Deformation (Impact).
⁸EN 166 European Anti-Fog standard-continuous photometric measurement of luminous transmittance of sample exposed to fog-conducive environment. Measures point of loss of 20% of clarity.
⁹ASTM D 870: Practice for Testing Water Resistance of Coatings Using Water Immersion. Measure of Anti-fog performance (w/EN 166) after 96 hours of continual aqueous exposure followed by conditioning at 25° C./70-75% relative humidity for 24 hours before testing.

### Example 7

Example 7 illustrates the preparation of another water-repellant, anti-fog coating for low-temperature usage. The prepolymer solution follows: In a 10-L polyethylene tank equipped with a gear-driven stirrer and an immersion heater, 1948 grams of caprolactam-blocked TDI prepolymer with an equivalent weight of 1395 was stirred with 400 grams of 4-hydroxy-4-methyl-2-pentanone and 200 grams of 2-butoxy ethanol to produce a solution of blocked polyisocyante in solvent.

A 3-L dual-necked round-bottomed flask was equipped with a magnetic stirrer, reflux condenser, and a heating mantle. A mixture of 855 grams of powdered PEG-4600 and 200 grams of PEG-1000 was poured into the flask and 400 grams of tert-butanol was added. Heat was then applied, and the solution was brought to reflux for 10 minutes to dissolve the PEG solids. The solution was cooled to 60° C., and then added to the prepolymer solution, with stirring. 2.8 grams of dibutyltin dilaurate (DBTDL) was stirred in for 15 minutes, and then 0.4 g each of L-7602 & L-7608 was added.

The solution was maintained at 50-55° C. via the immersion heater and filtered through a 0.5 micron cartridge filter. Glass panels were sprayed with a 0.25% of an amino-functional silicone adhesion-promoter (Silquest A-1106) in a 50/50 aqueous solution ethanol. After drying for 5 minutes at 20° C., the primed glass was exposed to IR lamps for 15 minutes to cure the primed surface, and then allowed to cool to room temperature.

The filtered, hot coating solution was applied to the primed glass panels and allowed to hang vertically at ambient conditions for 25 minutes. Samples were cured for 45 minutes at 150° C. via a forced-air convection oven. After curing, the samples were cooled to room temperature. The surface tension was found to be about 29 dynes/sq. cm, and the samples possessed excellent surface hardness.

The prepared samples were exposed to −10° C. for 5 minutes, and then exposed to a humidity test cabinet maintained at 20° C. and 80% relative humidity. The coated glass was found to maintain clarity indefinitely, and did not collect excessive moisture on its coated surfaces, i.e., the surface did not fog. Samples were also saturated in deionized water via immersion for 96 hours. After removal from the water, samples were subjected to low-temperature testing as above. The samples collected excessive moisture on their surfaces after 5 minutes of humidity cabinet exposure but did not fog. However, after allowing 30 minutes at 20° C. and 75% relative humidity for the saturated samples to equilibrate/dry out samples performed analogously to the initial test set. See Table 2 for summarized performance properties.

### Example 8

Similar to Example 7, 2782 grams of a pyrazole-blocked toluene diisocyanate prepolymer with an equivalent weight of 560 was stirred with 400 grams of 4-hydroxy-4methyl-2-pentanone and 250 grams of 2-butoxy ethanol to produce a solution of blocked polyisocyante in solvent.

A 3-L dual-necked round-bottomed flask was equipped with a magnetic stirrer, reflux condenser, and a heating machine. Powdered PEG-4600, 1060 g, was poured in and 400 g of 4-hydroxy-4-methyl-2-pentanone was added. Heat was then applied, and the solution was brought to reflux for 2 minutes to dissolve the PEG solids. The solution was cooled to 60° C., and then added to the prepolymer solution, with stirring. DBTDL 175 g, was stirred in for 60 minutes, and then 0.4 g each of L-7602 & L-7608 was added.

The solution was maintained at 50-55° C. via the immersion heater and filtered through a 1.0 micron cartridge filter. Glass panels were sprayed with a 0.25% of an amino-functional silicone adhesion-promoter (Silquest A-1106) in a 50/50 aqueous solution ethanol. After drying for 5 minutes at 20° C., the primed glass was cured for 15 minutes in a thermal convection oven at 60° C., and then allowed to cool to room temperature. The filtered, hot coating solution was applied to the primed glass panels and allowed to hang vertically at ambient conditions for 15 minutes. Samples were cured for 30 minutes at 125° C. via a convection oven. Samples were cooled to room temperature.

The samples were then exposed to −20° C. for 10 minutes, and then exposed to a humidity test cabinet maintained at 20° C. and 78% relative humidity. The coated glass was found to maintain clarity indefinitely, and did not collect excessive moisture on its coated surfaces. Samples were also saturated in deionized water for 96 hours. After removal from the water, samples were subjected to low-temperature testing as above. The samples were clear after 5 minutes of humidity cabinet exposure and maintained clarity indefinitely. See Table ?for summarized performance properties.

### Example 9

Example 9 was conducted as set forth above with respect to Example 7, except that 2-butoxyethanol was replaced with diacetone alcohol (DAA), using the same amount. Example 9 exhibited similar properties to Example 7, except Example 9 exhibited superior hardness. This Example shows the effect solvents have on the final surface hardness. See Table 2 for summarized performance properties.

### Example 10

Example 10 was conducted as set forth above with respect to Example 9, except the mixture was applied with a spray appliance, which produces a much thinner coating—about 2-3 microns. The anti-fog results were similar to Example 7, however, the coating fogged only after saturation and repetition of low-temperature exposure to test chamber. It did not fog if allowed to equilibrate/dry out. See Table 2 for summarized performance properties.

### Example 11

This Example was the same as Example 8, except it was sprayed. The results were essentially identical to Example 8. It was a more hydrophilic/anti-fog due to the reduced molecular weight of the polyol(s), despite thickness variance. See Table 2 for summarized performance properties.

### Example 12

This Example was the same as Example 8, except that PEG-1000 in the same amount was substituted for the PEG of Example 8. In addition, 2-butoxyethanol was replaced with 200 g of isophorone, and 2 grams of DC-57 was added. The coating fogged in 25 seconds upon removal from low low-temperature (−12° C. for 5 minutes) & exposure to humidity cabinet. After saturation and soak, the substrate fogged immediately when brought from freezer to test chamber. This shows the effect of using a lower molecular weight polyol. See Table 2 for summarized performance properties.

### Example 13

This Example was the same as Example 8, except Baxenden BI 7986 (an HDI biuret blocked with dimethylpyrazole) was substituted for the blocked isocyanate of Example 8. In addition, 1250 grams of PEG 4000 was substituted for the PEG of Example 8. This is an example of an alternated polyisocyante. See Table 2 for summarized performance properties.

TABLE 2

| | | | Taber Test % | | Pencil | Chemical | | Water Soak- |
|---|---|---|---|---|---|---|---|---|
| ID | LT %¹ | Haze %² | % Haze³ | Adhesion %⁴ | hardness⁵ | Resistance⁶ | Anti-fog⁸ | AF⁹ |
| 7 | >97 | <0.5 | 6.9 | 100 | 6H | Pass all | Pass 5 min | Pass 3 min |
| 8 | >96 | <0.5 | 1.2 | 100 | 10H | Pass all | Pass 5 min | Pass 5 min |
| 9 | >99 | <0.5 | 2.1 | 100 | 8H | Pass all | Pass 5 min | Pass 3 min |
| 10 | >99 | <0.2 | 8.3 | 100 | 4H | Fail Acetone | Pass 3 min | Pass 1 min |
| | | | | | | Fail Xlene | | |
| | | | | | | Pass others | | |
| 11 | >97 | <0.5 | 6.0 | 100 | 6H | Fail Acetone | Pass 3 min | Pass 2 min |
| | | | | | | Fail Xlene | | |
| | | | | | | Pass others | | |
| 12 | >93 | <0.5 | 12.8 | 100-tacky | 3H | Fail acetone | Pass 40s | Fail |
| | | | | | | Pass others | | |
| 13 | >93 | <0.3 | 5.5 | 100 | 6H | Pass all | Not | Not |
| | | | | | | | available | available |

### Example 14

Part A was mixed with Part B using simple stirring, namely, a magnetic stir bar and plate to form the mixture. Part A comprised 51.45 grams of trixene 7683 (commercially available from Baxenden of Lancashire, England) well mixed with 20.67 grams of diacetone alcohol. Part B comprised 20.67 grams of diacetone alcohol well mixed with 27.79 grams of polyethylene glycol 4600 (i.e. PEG having a molecular weight of 4600), 0.053 grams of dibutyl tin dilaurate (obtained from Gelest of PA, USA) and 0.037 grams of DC-28 (obtained from Dow Corning). The mixture was immediately applied using flow-coating to a 4” square of Teflon coated metal, and allowed to stand at ambient conditions for about 10 minutes. The mixture was then baked for about 1 hour at about 125° C. The resultant film was then peeled off the metal.

### Example 15

Part A was mixed with Part B using simple stirring, namely, a magnetic stir bar and plate to form the mixture. Part A comprised 51.45 grams of trixene 7683 (commercially available from Baxenden of Lancashire, England) well mixed with 20.68 grams of diacetone alcohol. Part B comprised 20.68 grams of diacetone alcohol well mixed with 27.79 grams of polyethylene glycol 4600, 0.053 grams of dibutyl tin dilaurate (obtained from Gelest of PA, USA), and 0.018 grams of L-7602 (obtained from Crompton of Pittsburg, Pa., USA) and 0.018 grams of L-7608 (obtained from Crompton). These last two components are flow/leveling aids and slip-aids, respectively. The mixture was immediately applied using flow-coating to a 4″ square of Teflon coated metal, and allowed to stand at ambient conditions for about 10 minutes. The mixture was then baked for about 1 hour at about 125° C. The resultant film was then peeled off the metal.

### Example 16

Part A was mixed with Part B using simple stirring, namely, a magnetic stir bar and plate to form the mixture. Part A comprised 42.88 grams of trixene 7683 (commercially available from Baxenden of Lancashire, England) well mixed with 33.85 grams of diacetone alcohol. Part B comprised 33.85 grams of diacetone alcohol well mixed with 23.18 grams of polyethylene glycol 3000 (i.e. having a molecular weight of 3000), 0.053 grams of dibutyl tin dilaurate (obtained from Gelest of PA, USA) and 0.037 grams of DC-28 (obtained from Dow Corning). The mixture was immediately applied using flow-coating to a 4″ square of Teflon coated metal, and allowed to stand at ambient conditions for about 10 minutes. The mixture was then baked for about 1 hour at about 125° C. The resultant film was then peeled off the metal.

### Example 17

Part A was mixed with Part B using simple stirring, namely, a magnetic stir bar and plate to form the mixture. Part A comprised 42.67 grams of trixene 7683 (commercially available from Baxenden of Lancashire, England) well mixed with 33.75 grams of diacetone alcohol. Part B comprised 33.75 grams of diacetone alcohol well mixed with 23.49 grams of polyethylene glycol 3000, 0.053 grams of dibutyl tin dilaurate (obtained from Gelest of PA, USA) and 0.037 grams of DC-28 (obtained from Dow Corning). The mixture was immediately applied using flow-coating to a 4″ square of Teflon coated metal, and allowed to stand at ambient conditions for about 0 minutes. The mixture was then baked for about 1 hour at about 125° C. The resultant film was then peeled off the metal.

### Example 18

Part A was mixed with Part B using simple stirring, namely, a magnetic stir bar and plate to form the mixture. Part A comprised 42.88 grams of trixene 7683 (commercially available from Baxenden of Lancashire, England) well mixed with 33.91 grams of diacetone alcohol. Part B comprised 33.91 grams of diacetone alcohol well mixed with 11.56 grams of polyethylene glycol 3000, 11.56 grams of polyethylene glycol 3000, 0.053 grams of dibutyl tin dilaurate (obtained from Gelest of PA, USA) and 0.037 grams of DC-28 (obtained from Dow Corning). The mixture was immediately applied using flow-coating to a 4″ square of Teflon coated metal, and allowed to stand at ambient conditions for about 10 minutes. The mixture was then baked for about 1 hour at about 125° C. The resultant film was then peeled off the metal.

### Example 19

Part A was mixed with Part B using simple stirring, namely, a magnetic stir bar and plate to form the mixture. Part A comprised 42.88 grams of trixene 7683 (commercially available from Baxenden of Lancashire, England) well mixed with 33.91 grams of diacetone alcohol. Part B comprised 33.91 grams of diacetone alcohol well mixed with 11.56 grams of polyethylene glycol 12000 (i.e. molecular weight 12000), 11.56 grams, of polyethylene glycol 1000, 0.053 grams of dibutyl tin dilaurate (obtained by Gelest of PA, USA) and 0.037 grams of DC-28 (obtained from Dow Corning). The mixture was immediately applied using flow coating to a 4″ square of Teflon coated metal, and allowed to stand at ambient conditions for about 10 minutes. The mixture was then baked for about 1 hour at about 125° C. The resultant film was then peeled off the metal.

### Example 20

Part A was mixed with Part B using simple stirring, namely, a magnetic stir bar and plate to form the mixture. Part A comprised 35.75 grams of trixene 7683 (commercially available from Baxenden of Lancashire, England) well mixed with 42.98 grams of diacetone alcohol. Part B comprised 42.98 grams of diacetone alcohol well mixed with 21.22 grams of polyethylene glycol 1000, 0.028 grams of dibutyl tin dilaurate (obtained by Gelest of PA, USA), 0.011 grams of L-7602 (obtained from Crompton of Pittsburgh, Pa., USA) and 0.011 grams of L-7608 (obtained from Crompton). The mixture was immediately applied using flow-coating to a 4″ square of Teflon coated metal, and allowed to stand at ambient conditions for about 10 minutes. The mixture was then baked for about 1 hour at about 125° C. The resultant film was then peeled off the metal.

### Example 21

Part A was mixed with Part B using simple stirring, namely, a magnetic stir bar and plate to form the mixture. Part A comprised 35.75 grams of trixene 7683 (commercially available from Baxenden of Lancashire, England) well mixed with 42.98 grams of diacetone alcohol. Part B comprised 42.98 grams of diacetone well mixed with 21.22 grams of polyethylene glycol 1500, 0.028 grams of dibutyl tin dilaurate (obtained by Gelest of PA, USA), and 0.011 grams of L-7602 (obtained from Crompton of Pittsburgh, Pa., USA) and 0.011 grams of L-7608 (obtained from Crompton). The mixture was immediately applied using flow-coating to a 4″ square of Teflon coated metal, and allowed to stand at ambient conditions for about 10 minutes. The mixture was then baked for about 1 hour at about 125° C. The resultant film was then peeled off the metal.

We claim:

1. A composition comprising:
an isocyanate prepolymer containing two or three isocyanate groups; and
a polyol,
the composition being capable of providing a scratch-resistant, water repellent, anti-fog finish, film or shape when cured.

2. The composition of claim 1, wherein the polyol comprises a water soluble or dispersible polyhydroxyl-functional compound.

3. The composition of claim 2, wherein the compound comprises at least one of a polyalkylene glycol, a water soluble triol, a tetrahydroxy functional, a branched ethylene oxide/propylene glycol copolymer, any block polymer thereof and combinations thereof.

4. The composition of claim 1, further comprising a catalyst.

5. The composition of claim 1, further comprising at least one of a leveling agent, mar-resistant additive and combination thereof.

6. The composition of claim 1, further comprising at least one of tertiary butyl alcohol, diacetone alcohol, isophorone, glycol ether EB(2-butoxy ethanol), and a combination thereof.

7. The composition of claim 1, wherein the isocyanate comprises at least one of a biuret, an isocyanurate of a diisocyanate, and a combination thereof.

8. The composition of claim 1, wherein the isocyanate is blocked.

9. The composition of claim 1, wherein the composition is substantially free of surfactants.

10. The composition of claim 1, wherein the composition is substantially free of chain extenders.

11. A method of producing a substantially scratch-resistant, anti-fog finish on a substrate, the method comprising:
mixing a blocked isocyanate having two or three isocyanate groups with a polyol to form a mixture;
applying the mixture to a substrate; and
curing the mixture to form a scratch-resistant, anti-fog urethane on the substrate.

12. The method of claim 11, further comprising adding a catalyst to the mixture.

13. The method of claim 11, further comprising adding at least one of a leveling agent, a mar-resistant additive, and combination thereof to the mixture.

14. The method of claim 11, wherein the mixture further comprises blocked isocyanates polar solvents containing primary and secondary alcohols.

15. The method of claim 11, wherein the mixture further comprises a solvent chosen from an alcohol, ketone, aliphatic, aromatic, ester, glycol ether, and mixture thereof.

16. The method of claim 11, wherein the mixture further comprises a solvent, and the substrate is a plastic.

17. The method as in claim 11, wherein the composition is substantially solvent free.

18. The method of claim 11, wherein the mixture further comprises a solvent, and the substrate is plastic or glass.

19. The method of claim 11, wherein the urethane comprises a color tint.

20. The method of claim 1 1, wherein the urethane is thermoformed.

21. The method of claim 11, wherein the mixture is substantially free of surfactants.

22. The method of claim 11, wherein the mixture is substantially free of chain extenders.

23. A polymer composition comprising:
a blocked isocyanate prepolymer containing two or three isocyanate groups;
a water soluble or dispersible polyhydroxyl-functional compound;
the composition being capable of providing a scratch-resistant, water repellent, anti-fog finish, film or shape when cured at a temperature of about 80° to 180° C. for about 10 to about 60 minutes, and the composition being substantially free of chain extenders and surfactants.
